(19) United States
(12) Patent Application Publication
(10) Pub. No.: US 2008/0294562 A1
(43) Pub. Date: Nov. 27, 2008

(54) Storage Medium Processing Method, Storage Medium Processing Device, and Program

(75) Inventors: Akihiro Kasahara, Chiba (JP); Akira Miura, Kanagawa (JP); Hiroshi Suu, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/571,942

(22) PCT Filed: Jun. 24, 2005
(86) PCT No.: PCT/JP2005/011607

§ 371 Date: Feb. 2, 2007

(30) Foreign Application Priority Data
Jul. 15, 2004 (JP) 2004-208321

(51) Int. Cl. H04L 9/32

(52) U.S. Cl. 705/59

(57) ABSTRACT

The content data is offered not only to specific storage media but also to the storage media of several different types. Various kinds of storage media (SDq, MSq, HDDq, etc.) enabled to acquire data from a license center unit 40 is provided with different type-identifier data IDs. This data is stored in a type identifier database 42. In case of acquisition request of the user key data from the each storage medium, the type identifier data IDs is shown with the medium identifier data IDm.

### FIELD OF THE INVENTION

The present invention relates to a storage-medium processing method, a system, and a program, which enables a user terminal to acquire content data or the like from a license center device, by online-connecting a storage medium conforming to a double key encryption scheme via a user terminal to the license center device.

### BACKGROUND OF THE INVENTION

In recent years, with development of information society, a content data distribution system is widely used. In this system, the content data including electronic data such as a book, newspaper, music, or an moving pictures, is distributed to a user terminal, which enables browsing of content data in the user terminal.

However, since electric content data (heretofore, it is referred to as “content data”) can be copied easily, the electronic content data tends to induce illegal acts that disregard copyright. From a viewpoint of protecting content data from such an illegal act, content data is encrypted and recorded by the encryption key and is usually decoded at the time of reproducing.

Content data protection technologies like this include CPRM (Content Protection for Prerecorded Media) which uses a standardized encryption key scheme in SD audio, SD video, SD E-e-Publish (SD computer-assisted publishing) or the like (for example, refer to nonpatent literature 1). The encryption-key scheme adapted in this nonpatent literature 1 is an encryption single key scheme which enciphers a title key with a medium unique key. On the other hand, the encryption double key scheme in which the content key is doubly encrypted with the user key and the medium unique key is known (for example, refer to nonpatent literature 2). This kind of encryption double key scheme is used in MQbic (registered trademark), for example.

FIG. 8 is a schematic diagram showing the configuration of the SD card and a user terminal corresponding to the encryption double key scheme adopted in Mqbic. An SD card SDq is an example of a secure storage medium which securely stores data. The SD card SDq has a system area 1, a hidden area 2, a protection area 3, a user data area 4, and an encryption/decryption unit 5, and the data is stored in each area 1-4.

In a SD card SDq like this, key management information MKB (Media Key Block) and the medium identifier IDm are stored in the system area 1. The medium unique key Kmu is stored in the hidden area 2. The encrypted user key Enc (Kmu, Ku) is stored in the protection area 3, and the encrypted content key data Enc (Ku, Kc) is stored in the user data area 4. The expression of Enc (A, B) means the data B encrypted with data A in this specification. Here, the user key Ku is encryption/decryption key to the content key Kc, and is used in common also to two or more encrypted content key data Enc (Ku, Kc1), Enc (Ku, Kc2) . . . . Moreover, the subscript q of the SD card SDq denotes that it conforms to MQbic (registered trademark).

Here, the system area 1 is a read-only area which can be accessed from outside of the SD card. The hidden area 2 is a read-only area that the SD card itself refers to, and cannot be accessed at all from external. The protection area 3 is an area in which data read and write is possible from external of the SD card when authentication is accomplished.

The user data area 4 is an area in which read/writing is freely possible from outside of the SD card. The encryption/decryption unit 5 performs authentication, key exchanging, and cryptography, and has a function of encryption/decryption.

The user terminal 20q for reproducing operates logically as follows to such the SD card SDq. That is, the user terminal 20q, performs MKB processing of the key management information MKB read from the system area 1 of the SD card SDq with the device key Kd set up beforehand (S1), to obtain a medium key Km. Next, the user terminal 20q carries out the hash processing of both the medium key Km and the medium identifier IDm read from the system area 1 of the SD card SDq (S2), and obtains the medium unique key Kmu.

Thereafter, the user terminal 20q performs, based on the medium unique key Kmu, an authentication process and a key exchanging process (AKE: Authentication Key Exchange) with the decryption/encryption unit 5 of the SD card SDq, to share a session key with the SD card SDq (S3).

Note that the authentication and key exchanging process in the step S3 succeeds when the medium unique key Kmu in the hidden area 2 referred to at the decryption/encryption unit 5 coincides with the medium unique key Kmu generated by the user terminal 20q, thereby the session key Ks being shared.

Then, the user terminal 20q reads out the encrypted user key Enc (Kmu, Ku) from the protection area 3, through a cipher communication using the session key Ks (S4). This results in the encrypted user key Enc (Kmu, Ku) being decrypted by the medium unique key Kmu (S5). Then, the user key Ku will be obtained.

Finally, when the encrypted content key Enc (Ku, Kc) is read from the user data area 4 of the SD card SDq, the user terminal 20q carries out the decryption processing of the encrypted content key Enc (Ku, Kc) with the user key Ku to obtain a content key Kc (S5q). Finally, when the encrypted content data Enc (Kc, C) is read from Memory 11q, the user terminal 20q performs the decryption processing of the encrypted content data Enc (Kc, C) with the content key Kc (S6). Thereby, the user terminal 20q reproduces the obtained content data C.

Note that although the above-mentioned example stores encrypted content data in the memory 11q of the user terminal 20q it may be stored in the external storage medium.

The above-mentioned encryption double key scheme stores encrypted content key data at the user data area 4 having a large memory capacitance compared to the protection area 3. Therefore, it has an advantage in that it can store a lot of encrypted content key data compared to encryption single key scheme.

Moreover, since the encryption double key scheme may store encrypted content data in the SD card, it may urge the distribution of encrypted content data.

Furthermore, in the encryption double key scheme, the medium identifier as an identifier is given to each SD card, and a unique user key is issued per medium identifier. This user key is also encrypted and stored in the protection area (protected area) of an SD card. Encryption of the user key depends on the medium identifier, and the user key can be decoded only with a authentic player. For this reason, content data cannot be acquired even if a trespasser copies only a content key unjustly from a user data area.

[Nonpatent literature 1] 4C An entity, LLC, [online], Internet <URL: http://www 4Centity.com/, searched on Jun. 14, 2004>[Nonpatent literature 2] IT information site and ITmedia news [online], Internet<URL:http://www.itmedia.co.jp/news/0307/18/njbt_{—}02.html, searched on Jun. 14, 2004>

### DISCLOSURE OF THE INVENTION

### Problem to be Solved

By the way, when a holder of the user terminal 20q acquires the content data or the like in the content distribution system using such an encryption double key scheme, it is necessary to request issuance of the user key data Ku to a license center (not shown in FIG. 8) from the user terminal 20q beforehand to acquire the user key data Ku. When outputting this request, the user terminal 20q presents the medium identifier data IDm of the SD card SDq, and receives a delivery of a different unique user key Ku for every medium identifier data.

However, in a system distributing a user key based on the medium identifier data IDm only, content data could be distributed only to specific media (for example, SD card). Content data cannot be distributed to general media (for example, Memory Stick (registered mark) famous as another system, and a portable hard disk drive). It is because medium identifier data is assigned based on regulations defined by each of the SD card camp and the Memory Stick camp respectively, and the same medium identifier data may be given to an SD card and another Memory Stick.

### SUMMARY OF THE INVENTION

A storage medium processing method according to the invention uses a storage medium and a user terminal.

The storage medium stores at least encrypted user key data in which user key data is encrypted so that it may be decrypted, and encrypted content key data in which content key data is encrypted so that it may be decrypted using the user key data.

The user terminal is configured to be connectable to the storage medium, and the user terminal is enabled to access to a license center to obtain various kinds of data.

The method comprises: a user key data requesting step in which the user terminal requests to the license center an issuance of the user key data submitting type identifier data specifying a type of the storage medium with medium identifier data for discriminating one of storage media belonging to the same type; and a user key data issuance step in which the license center issues different user key data per combination of the type identifier data and the medium identifier data submitted.

A storage medium processing method according to the invention uses a storage medium and a user terminal.

The storage medium stores at least encrypted user key data in which user key data is encrypted so that it may be decrypted, and encrypted content key data in which content key data is encrypted so that it may be decrypted using the user key data.

The user terminal is configured to be connectable to the storage medium, and the user terminal is enabled to access to a license center to obtain various kinds of data. The method comprises: a content key data requesting step in which the user terminal requests to the license center an issuance of content key data submitting type identifier data specifying a type of the storage medium with medium identifier data for discriminating one of storage media belonging to the same type; and a content key data transmitting step in which the license center refers to a user key database storing the user key data as being related to the type identifier data and the medium identifier data, reads from the user key database the user key data corresponding to the type identifier data and the medium identifier data submitted at the content key data requesting step, and transmitting the content key data concerning the request to the user terminal after encrypting it with the user key data.

A storage medium processing device according to the invention is enabled to be connected to a storage medium storing at least encrypted user key data in which user key data is encrypted so that it may be decrypted, and encrypted content key data in which content key data is encrypted so that it may be decrypted using the user key data. The device is configured to perform data processing of the storage medium via a user terminal. The device comprises: a receiver receiving a request of issuing the user key data accompanied by type identifier data specifying a type of the storage medium and medium identifier data for discriminating one of storage media belonging to the same type; a key issuance unit issuing different user key data per combination of the type identifier data and the medium identifier data; a transmitter that encrypts and transmits the key issued by the key issuance unit to the user terminal; and a user key database storing the user key data issued, as being related to the type identifier data and the medium identifier data.

A storage medium processing program according to the invention uses a storage medium and a user terminal.

The storage medium stores at least encrypted user key data in which user key data is encrypted so that it may be decrypted, and encrypted content key data in which content key data is encrypted so that it may be decrypted using the user key data.

The user terminal is configured to be connectable to the storage medium, and the user terminal is enabled to access to a license center to obtain various kinds of data.

The program is configured to perform: a user key data requesting step in which the user terminal requests to the license center an issuance of the user key data submitting type identifier data specifying a type of the storage medium with medium identifier data for discriminating one of storage media belonging to the same type; and a user key data issuance step in which the license center issues different user key data per combination of the type identifier data and the medium identifier data submitted.

A storage medium processing program according to the invention uses a storage medium and a user terminal.

The storage medium stores at least encrypted user key data in which user key data is encrypted so that it may be decrypted, and encrypted content key data in which content key data is encrypted so that it may be decrypted using the user key data.

The user terminal is configured to be connectable to the storage medium, and the user terminal is enabled to access to a license center to obtain various kinds of data. The program is configured to perform: a content key data requesting step in which the user terminal requests to the license center an issuance of content key data submitting type identifier data specifying a type of the storage medium with medium identifier data for discriminating one of storage media belonging to the same type; and a content key data transmitting step in which the license center refers to a user key database storing the user key data as being related to the type identifier data and the medium identifier data, reads from the user key database the user key data corresponding to the type identifier data and the medium identifier data submitted at the content key data requesting step, and transmitting the content key data concerning the request to the user terminal after encrypting it with the user key data.

### THE ADVANTAGE OF THE INVENTION

According to the present invention, each storage medium is discriminated by the combination of the type identifier data and the medium identifier data. Therefore, content data may be provided not only to specific storage media but also to different plural types of storage media (SD cards Memory Sticks and so forth).

### EMBODIMENTS

Hereafter, embodiments of the present invention will now be described with reference to the drawings. FIG. 1 is a diagram showing the configuration of the storage-medium processing system relating to the embodiment of the present invention.

The same numerals are given to the same parts as FIG. 8, and detailed explanation is omitted for these parts. Different parts are hereafter mainly described.

Specifically, in the system of this embodiment, user terminals 20 (A-D) each hold a storage medium such as a SD card SDq, a Memory Stick MS, and a portable hard disk drive HDDq and so forth. These media are attached to the user terminals freely attachable and detachable therein. The user terminals 20 can communicate with the license center unit 40 through a network 30.

The user terminals 20 A-D each have a memory 21 (A-D), a download unit 22 (A-D) a processing unit 23 (A-D) and a control unit 25 (A-D). For a user terminal 20, any arbitrary device may be used, if it is an electronic instrument holding a storage medium attachable and detachable therein or built therein (built-in), such as a personal computer, a portable cellular phone, or a portable information terminal (personal digital assistant). In FIG. 1, personal computers 20A and 20B, an audio player 20C, and a PDA 20D are illustrated as examples of the user terminals 20.

An SD card SDq as a storage medium shall be connected to a personal computer 20A. A Memory Stick SDq as a storage medium shall be connected to a personal computer 20B. Moreover, an SD card SDq′ as a storage medium shall be connected to the audio player 20C. A portable hard disk drive HDDq as a storage medium shall be connected to PDA20D.

The memories 21A-D are storage areas readable and writeable from the other units 22A-D, 23A-D, 24A-D, and 25A-D, respectively. For example, encrypted content data Enc (Kc, C) is stored therein.

The download units 22A-D are controlled by the control units 25A-D, and have a function of downloading the encrypted content key Enc (Ku, Kc) and the user key Ku from the license center unit 40. For example, browser software can be used.

The processing units 23A-D are controlled by the control units 25A-D, and have a function of authentication with a storage medium, a cipher communication, and executing reading/writing data stored in the storage media.

The control unit 25 has usual computer functions and a function of controlling each of the unit 21-24 according to operation of a user. Thereby, each recording media SDq, MSq, and HDDq are enabled to hold data by its original data holding scheme.

The license center unit 40 is equipped with a host computer 41, a type-identifier database 42, a medium-identifier database 43, a content key database 44, a user key database 45, and an authenticated content ID database 46.

The host computer 41 serves as a receiver receiving from the user terminals 20A-D through a network 30 a request of transmitting content key data or user key data. When the transmitting request is received, after experiencing a certain authentication process, the host computer 41 serves as an issuing unit that issues the content key data and the user key data concerning the request, and as a transmitting unit that transmits these kinds of key data to the user terminal 20 through a network 30.

The type-identifier database 42 holds type identifier data IDs. The type-identifier data IDs indicates types of storage media to which the license center unit 40 can provide the content data or the like. The “types” herein means classifications defined by differences in hardware structures, or read/write modes, as well as a manufacturer, a product number, and a memory capacity, depending on cases. More specifically, one of the product groups in which a rule of assigning medium identifier data IDm is unified makes up a “type” herein.

For example, in the case of the SD card SDq, the same type-identifier data IDs can be assigned, irrespective of the manufacturers or the storage capacities. It is because concerning SD cards SDq, plural manufacturers make up a rule for assigning medium identifier data so that all the different cards are provided with different medium identifier data IDm. This is the same also in a Memory Stick.

On the other hand, in other storage media, such as a hard disk, rules for assigning medium identifier data IDm may differ between manufacturers. Therefore, it is necessary to assign different type-identifier data IDs per manufacturer and product number. In the example of this FIG. 1, the SD card SDq and SDq′ have a type-identifier data “4A”. The Memory Stick MSq has a type-identifier data “4B”. And the portable hard disk drive HDDq has a type-identifier “4C” These kinds of data are stored in the type-identifier database 42.

The medium identifier database 43 holds the medium identifier data IDm for identifying one by one the storage media belonging to the same “type”. As shown in FIG. 2, the content key database 44 holds the content key data (a content Key) for encrypting/decrypting various content data, as being related to the data of content ID, the title of the content data and so forth.

As shown in FIG. 2, the user key database 45 holds the user key data Ku held by each storage media, with the type-identifier data IDs of each medium, the medium identifier data IDm, and the data (Invalid) indicating validness/invalidness of the key.

The authenticated content ID database 46 holds the content IDs corresponding to the content key data issued according to the requests from the user terminals 20 A-D, as being related to the type-identifier data IDs of the storage media and the medium identifier data IDm.

The security module 51 is a unit that performs encryption/decryption processing of the user key Ku and the content key Kc, and is equipped with a management key obtaining unit 52, and a key encryption management unit 53.

The management key obtaining unit 52 holds the management key readable from the host computer 41.

The key encryption management unit 53 has a function of receiving a setup of a management key by the host computer 41, decoding the encrypted user key for management and the encrypted content key for management respectively, which are received from the host computer 41 based on the management key to obtain a user key and a content key, encrypting the content key and basic metadata with the user key, and transmitting to the host computer 41 the encrypted content key (with basic metadata included therein) obtained and (additional) metadata such as a purchase date or the like.

### (Acquisition Process of a User Key)

Next, the process in which the storage medium accesses license center unit 40 through the user terminal 20 to acquire the user key Ku in this system is explained with reference to FIG. 3.

In the user terminal 20, the control unit 25 starts the processing unit 23 and the download unit 22 according to the operation of a user. The processing unit 23 specifies the type-identifier data IDs of the storage medium, while reading the medium identifier data IDm of the storage medium from the system area 1 (S11).

The type-identifier data IDs may be specified based on device-type automatic recognition function adopted in each of the user terminals 20, for example. Alternatively, it may be performed based on information input beforehand.

Moreover, the processing unit 23 generates a random number R1 by the random number generation unit not shown (512).

This random number R1 is generated for authentication under challenge response using a common-key-encryption scheme, and for generation of a session key, in order to perform secure communication between the user terminal 20 and the license center unit 40.

Then, the download unit 22 transmits acquisition request of the user key Ku to the host computer 41 (S13). This acquisition request contains the medium identifier data IDm of the storage medium, the type-identifier data IDs, and the random number R1.

In response to this acquisition request, the host computer 41 generates the user key Ku, after experiencing a certain authentication process or the like (S14).

And it stores this user key data Ku in user key database 45 as being related to the medium identifier data IDm and the type-identifier data IDs (515).

Subsequently, the host computer 41 generates the random number R2 (516). Like random number R1, this random number R2 is generated for authentication under challenge response using a common-key-encryption scheme, and for generation of a session key, in order to perform secure communication between the user terminal 20 and the license center unit 40.

Then, the session key Ks is generated using the random number R1 received from the processing unit 23, this random number R2, and the secret information K1 K2 as a common encryption key (517). The host computer 41 encrypts the user key Ku using this generated session key Ks by the security module 51 (S18), and transmits the encrypted user key data Ku using the simple object access protocol message with the random number R2 to the processing unit 23 through the download unit 25 (S19).

The processing unit 23 generates the session key Ks from the random number R1, R2, the secret information K1, and K2 (S20), and decodes the encrypted user key Ku with the session key Ks (S21). The decrypted user key Ku is again encrypted by the processing unit 23 using a unique key of the storage medium (if it is the SD card SDq, a medium unique key Kmu) and is written in the protection area of the storage medium (S22). This ends the acquisition process of the user key Ku.

### (Acquisition Process of the Content Key)

A process in which a storage medium acquires the content key data through the user terminal 20 is explained with reference to FIG. 4.

In the user terminal 20, the control unit 25 starts the download unit 22 according to the operation of a user. And as shown in FIG. 2, the download unit 22 checks that purchase or charge about the content key is finished beforehand (S31). If it is not finished yet, the user terminal 20 performs purchase and accounting process of the content key with the license center unit 40, and changes the content key's status as being already purchased and charged.

Then, the download unit 22 transmits the transmitting request of the encrypted content key data to be acquired and metadata to the host computer 41 (S32). Note that this transmitting request contains the content ID corresponding to the encrypted content key, the medium identifier data IDm of the storage medium, and the type-identifier data IDs at least.

When the host computer 41 receives this transmitting request, the host computer 41 reads from the user key database 45 the encrypted user key for management stored beforehand per combination of the medium identifier data IDm and the type-identifier data IDs (S33). Furthermore, it reads from the content key database 44 the encrypted content key for management and basic metadata (the content ID, the title, the manufacturer, and so forth) stored per content ID (S34).

Thereafter, the host computer reads from management key obtaining unit 52 the management key (S35). Then, the host computer 41 sets this management key as the key encryption management unit 53 (S36), and transmits a request of encrypting the content key to the key encryption management unit 53 (S37). Note that this encryption request contains the encrypted user key for management, the encrypted content key for management, and the basic metadata.

Based on the management key, the key encryption management unit 53 decodes the encrypted user key for management, and the encrypted content key for management, respectively, and obtains a user key and a content key.

Thereafter, the key encryption management unit 53 encrypts the content key and the basic metadata with the user key, and transmits to the host computer 41 the encrypted content key (with basic metadata included therein) and metadata (it is additional) such as an purchase date (S38).

The host computer 41 reads the additional metadata (S39), and generates a SOAP (Simple Object Access Protocol) message containing the encrypted content key and the metadata for example (S40). And it transmits the encrypted content key and metadata to the user terminal 20 by the SOAP message (S41). Note that the SOAP message is an example of a message scheme. It is needless to say that it may be changed into other schemes.

In the user terminal 20, the download unit 22 which received SOAP message sends out to the processing unit 23 a request of saving the encrypted content key data (S42). Note that the request of saving the encrypted content key contains only the encrypted content key out of the encrypted content key and metadata. The processing unit 23 writes this encrypted content key in the user data area of the storage medium.

Moreover, the download unit 22 saves the metadata that was not sent to the processing unit 23 (S43). This ends the acquisition process of the content key.

As described above in this embodiment, in the acquisition process of the user key data Ku, different user keys Ku are issued for every combination of the type-identifier data IDs and the medium identifier data IDm. In addition, also in the case of delivering the content key data Kc, the delivery is done using the user key Ku stored in user key database 45 for every combination of the type-identifier data IDs and the medium identifier data IDm. For this reason, the range of the content data delivery is not limited to specific storage media. It may be expanded to other types of storage media using other schemes, such as a Memory Stick and a hard disk drive.

Next, a storage medium processing system according to the second embodiment of the present invention is explained with reference to FIG. 5.

This embodiment shows a case where plural storage media are registered as “family cards” in a family card registration database 47. “Family cards” means that plural persons who have a specific relationship such as a family own a card respectively, and can receive privileges, such as discount. Specifically, let it suppose that among plural storage media registered as family cards, a “master” storage medium (here, the SD card SDqmi) acquired content key data Kc1. In this case, a “slave” storage medium having a subordination relationship can share this content key data Kc1.

The family card registration database 47 holds type-identifier data IDs and medium identifier data IDm of the other storage media that can share the content key data Kc obtained by the “master” storage medium.

Moreover, in this embodiment, the user key database 45 holds the user key data Ku of the other storage media registered as “family cards”, as being related to the type-identifier data IDs and the medium identifier data IDm.

For example, as shown in FIG. 5, let it suppose that the holder of a “master” SD card SDqm3 acquired a content key Kc1. In this case, that content key data Kc1 can be shared by the “slave” storage media, for example, a SD card SDqS3 (refer to FIG. 6).

The SD card SDqS3 has user key data Ku2 And this user key data Ku2 is stored in the user key database 45 like user key data Ku1 of the “master” SD card SDqm3 with the type-identifier data IDs and the medium identifier data IDm.

If there is a delivery request of content key data Kc1 acquired by the “master” from the “slave” SD card SDqS3, the host computer 41 refers to the family card registration database 47 using the type-identifier data IDs and the medium identifier data IDm attached to the delivery request. When the SD card SDqS3 turns out to be the “slave” of the SD card SDm3 as a result of the reference, the host computer 41 reads the user key data Kc2 of the SD card SDqS3 registered in the user key database 45. Further, it encrypts the content key data Kc1 with this user key data Kc2, and transmits it to the user terminal to which the SD card SDqS3 is connected.

In the above cases, both the “master” and the “slave” are the SD cards. However, as shown in FIG. 7, even when a “slave” is a Memory Stick MSqS2, steps of requesting or delivery are the same as that of FIG. 6. Only storing and protecting methods in the “slave” concerning the content key data Kc1 that is stored in the “master” are different.

Note that the process described in each of above-mentioned embodiments can be implemented by a program which can make a computer perform the process. The program can be stored in a storage medium, such as magnetic disks (a floppy (registered trademark) disk, a hard disk, etc.) an optical disk (CD-ROM, DVD etc.), a magneto-optical disk (MO), and a semiconductor memory.

Moreover, as this storage medium, scheme for storing may be of any type, as long as it is a storage medium enabled to store a program readable by a computer.

Moreover, operating system (OS) working on a computer based on an indication of the program installed in the computer from the storage medium, a database management software, and a middleware such as network software, can implement part of the processes for realizing the embodiments.

Furthermore, the storage medium in the present invention is not limited to the medium that is independent of a computer. It may be a storage medium that downloads the program transmitted by a local area network (LAN) or the Internet, etc and stores or temporarily stores it.

Moreover, a storage medium is not limited to a single one. When the processes in the embodiments are performed by a plurality of media, the media are included in the storage medium according to the present invention. In addition, the medium configuration can be any type.

Note that a computer in the present invention may be configured to perform each process in the embodiments based on a program stored in a storage medium. It may have any configurations. For example, it may be a single device such as a personal computer, or a system having a plurality of network-connected computers.

Moreover, a computer in the present invention is not limited to a personal computer, but includes a operation processing device included in a information processing device, and a microcomputer. It includes devices or apparatuses that can realize the function of the present invention by a program.

Furthermore, in the above-described embodiments, the update history by the medium identifier shown at the time of the update request is referred. As addition to this, it is possible to refer to the medium identifier shown in the user registration database 48, and when the matching user registration does not exist, the update of a user key may be refused.

Note that the present invention is not limited to the above-described embodiments themselves. In a practice phase, their components can be modified and embodied, as long as it does not depart from the spirit thereof. Moreover, merging two or more proper components indicated by the above-mentioned embodiments can form various inventions. For example, some components may be deleted from all the components shown in the embodiments. Furthermore, the components employed in different embodiments may be combined suitably.

### BRIEF DESCRIPTION OF THE DRAWINGS

FIG. 1 is a schematic diagram illustrating a configuration of a storage medium processing system according to a first embodiment of the present invention.

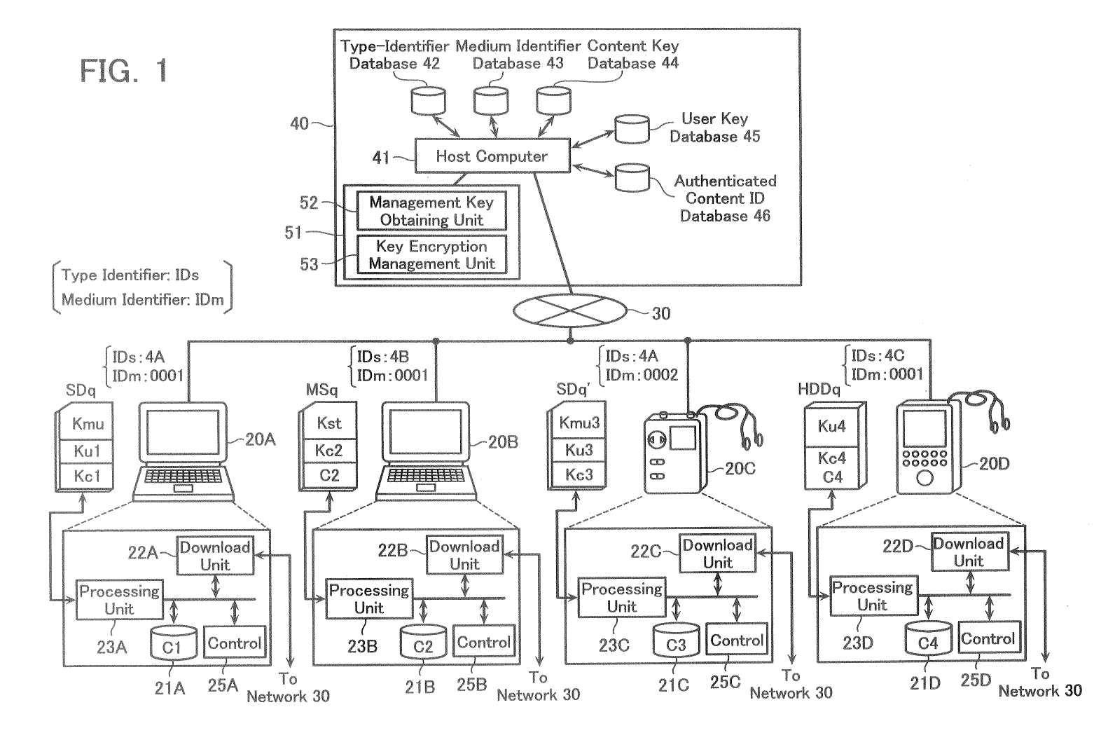

FIG. 2 explains configurations of the various databases shown in FIG. 1.

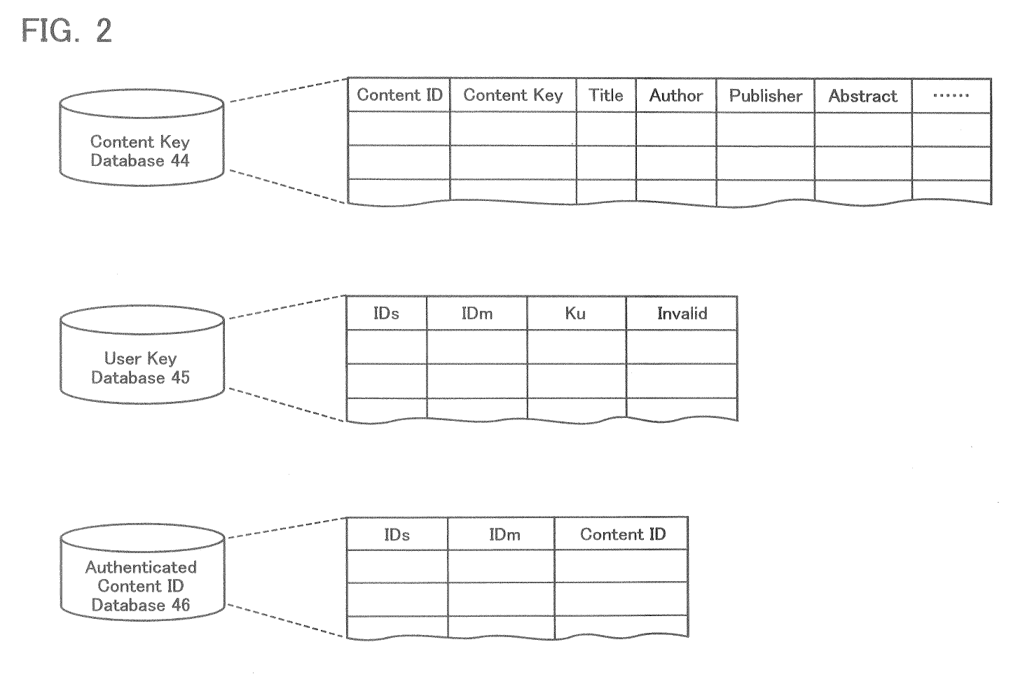

FIG. 3 explains procedures for obtaining a user key data Ku by a storage medium via a user terminal 20.

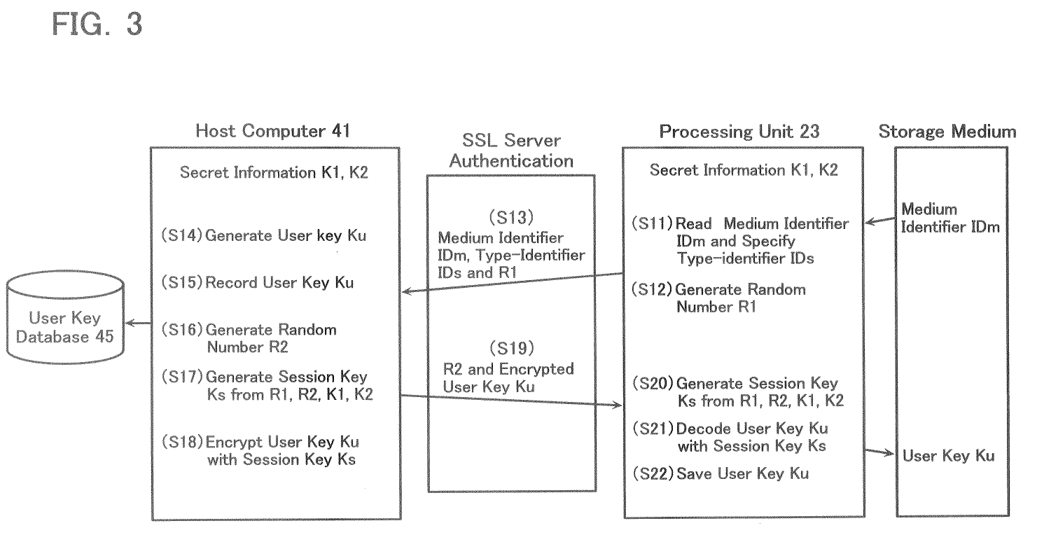

FIG. 4 explains a process in which a storage medium acquires the content key data through the user terminal 20.

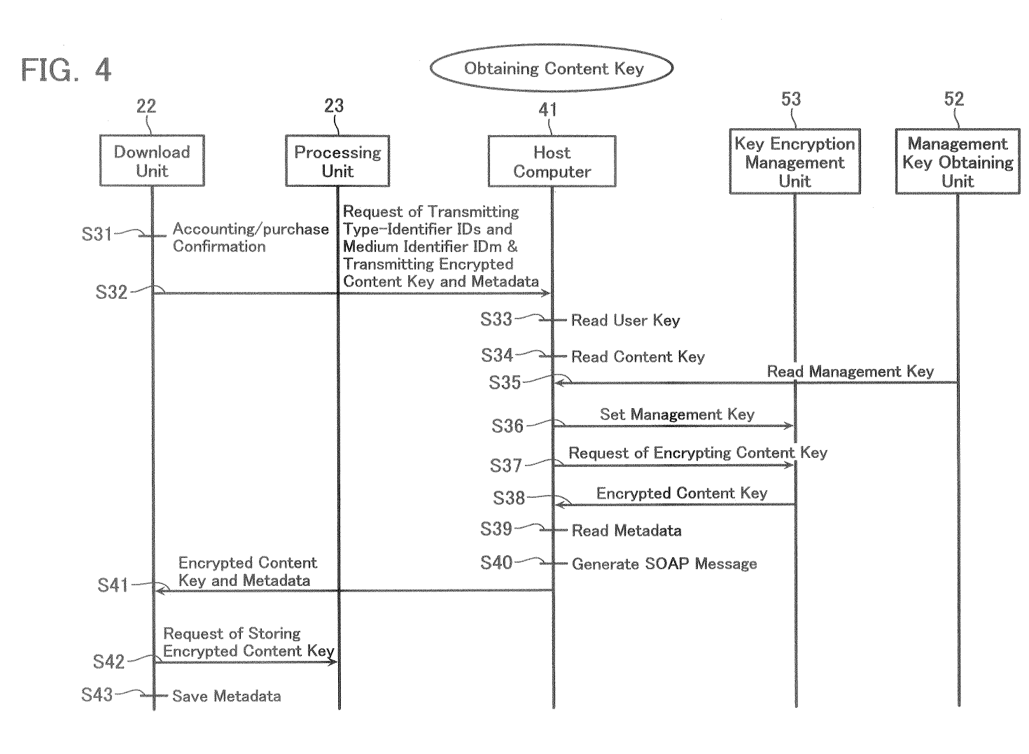

FIG. 5 is a schematic diagram illustrating a configuration of a storage medium processing system according to a second embodiment of the present invention.

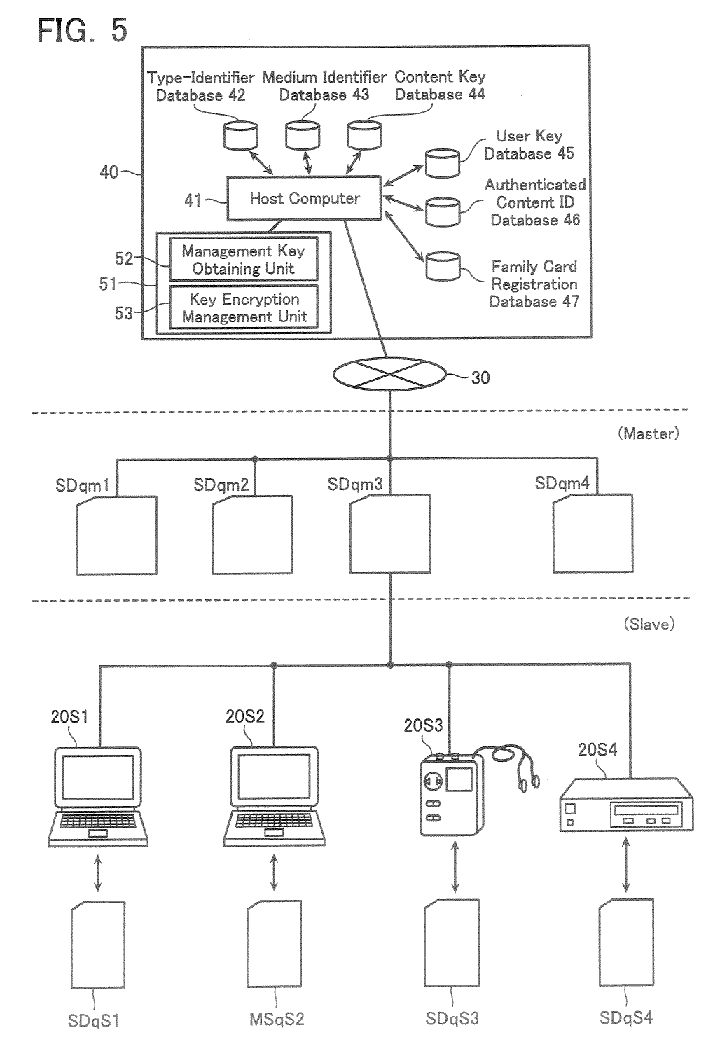

FIG. 6 shows how the storage medium processing system shown in FIG. 5 works.

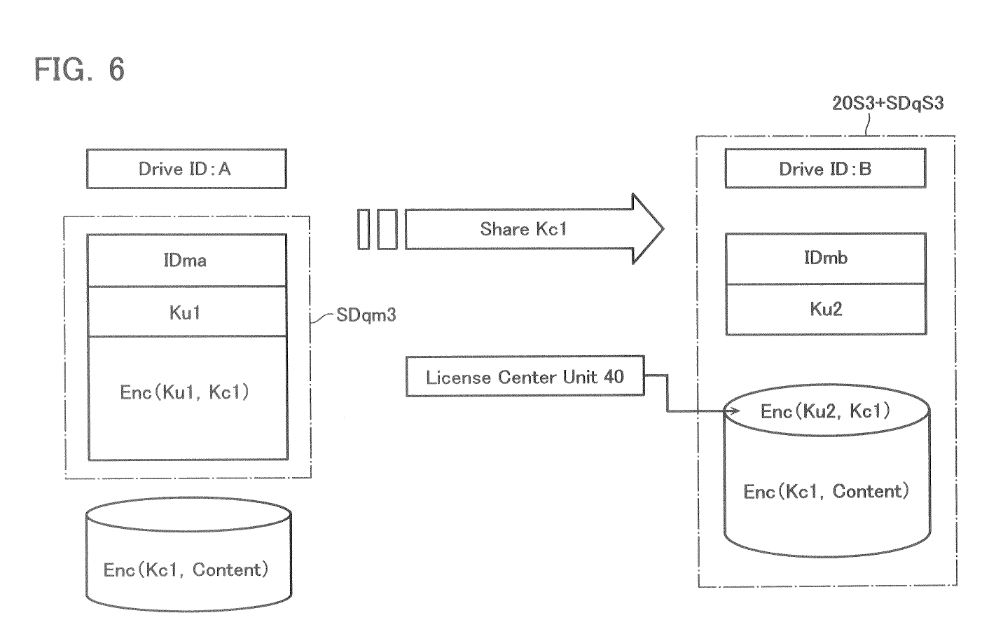

FIG. 7 shows how the storage medium processing system shown in FIG. 5 works.

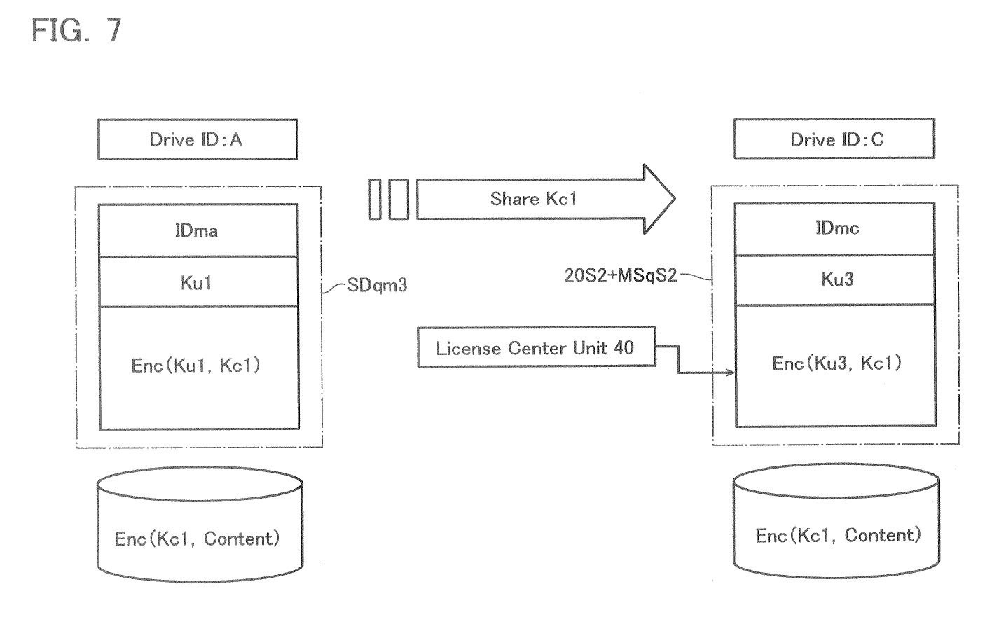

FIG. 8 is a diagram showing the configuration of the SD card and a user terminal conforming to the encryption double key scheme.

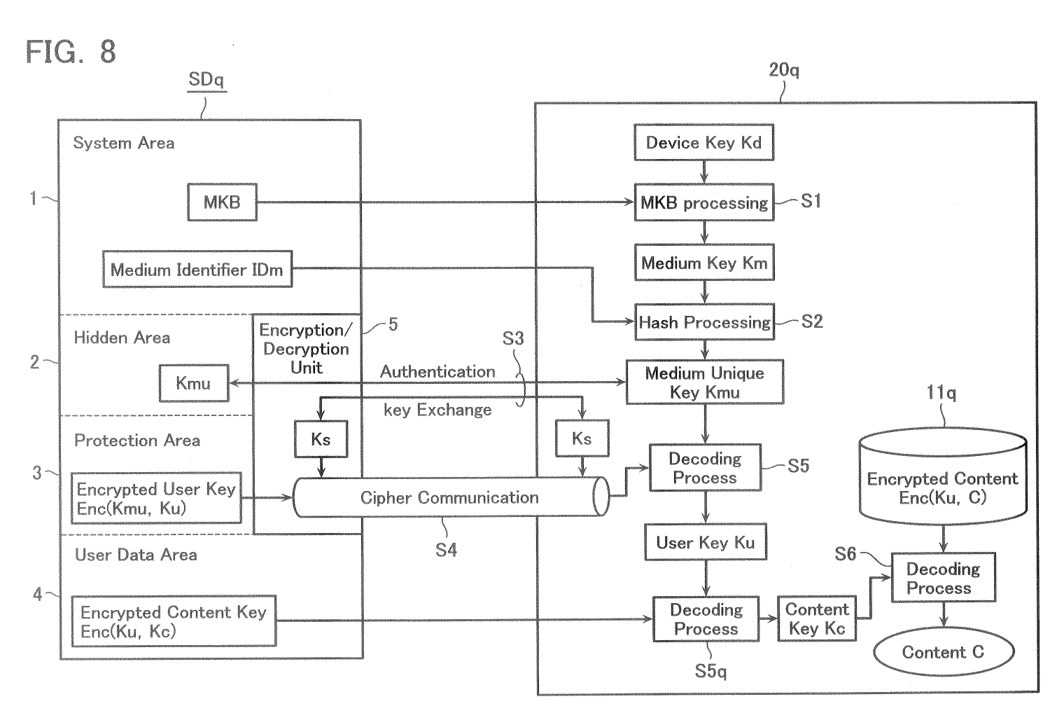

### AN EXPLANATION OF SYMBOLS

SDq . . . an SD card
1 a system area
2 a hidden area
3 a protection area
4 . . . a user data area
5 . . . a encryption/decryption unit
20 . . . a user terminal
21 . . . a memory
22 . . . a download unit
23 . . . a processing unit
25 . . . a control unit
40 . . . a license center unit
41 . . . a host computer
42 . . . a type-identifier database
43 . . . a medium identifier database
44 . . . a content key database
45 . . . a user key database
46 . . . The authenticated content ID database
51 . . . The security module
52 . . . a management key obtaining unit
53 . . . a key encryption management unit

1. A storage medium processing method a using a storage medium and a user terminal,
wherein the storage medium stores at least encrypted user key data in which user key data is encrypted so that it may be decrypted, and encrypted content key data in which content key data is encrypted so that it may be decrypted using the user key data and the user terminal is configured to be connectable to the storage medium, and is enabled to access to a license center to obtain various kinds of data,
the method comprising:
a user key data requesting step in which the user terminal requests to the license center an issuance of the user key data submitting type identifier data specifying a type of the storage medium with medium identifier data for discriminating one of storage media belonging to the same type; and
a user key data issuance step in which the license center issues different user key data per combination of the type identifier data and the medium identifier data submitted.

2. A storage medium processing method a using a storage medium and a user terminal,
wherein the storage medium stores at least encrypted user key data in which user key data is encrypted so that it may be decrypted, and encrypted content key data in which content key data is encrypted so that it may be decrypted using the user key data, and the user terminal is configured to be connectable to the storage medium, and is enabled to access to a license center to obtain various kinds of data,
the method comprising:
a content key data requesting step in which the user terminal requests to the license center an issuance of the content key data submitting type identifier data specifying a type of the storage medium with medium identifier data for discriminating one of storage media belonging to the same type; and
a content key data transmitting step in which the license center refers to a user key database storing the user key data as being related to the type identifier data and the medium identifier data, reads from the user key database the user key data corresponding to the type identifier data and the medium identifier data submitted at the content key data requesting step, and transmitting the content key data concerning the request to the user terminal after encrypting it with the user key data.

3. The storage medium processing method according to claim 1, further comprising:
a family card registration step storing a family card registration data providing other storage media sharing content key data obtained in the storage medium in a family card registration database;
a memory step storing user key data of the other storage media provided in the family card registration data in a user key database as being related to the type identifier data and the medium identifier data; and
a step in which the license center refers to the family card registration database and delivers the content key data held in the storage medium registered as a family card to the other storage medium, when the other storage medium requests the license center to transmit content key data while submitting the type identifier data and the medium identifier data.

4. A storage medium processing device enabled to be connected to a storage medium storing at least encrypted user key data in which user key data is encrypted so that it may be decrypted, and encrypted content key data in which content key data is encrypted so that it may be decrypted using the user key data, and configured to perform data processing of the storage medium via the a user terminal,
the device comprising:
a receiver receiving a request of issuing the user key data accompanied by type identifier data specifying a type of the storage medium and medium identifier data for discriminating one of storage media belonging to the same type;
a key issuance unit issuing different user key data per combination of the type identifier data and the medium identifier data;
a transmitter that encrypts and transmits the key issued by the key issuance unit to the user terminal; and
a user key database storing the user key data issued, as being related to the type identifier data and the medium identifier data.

5. The storage medium processing device according to claim 4, wherein the receiver is configured to receive a delivery request of the content key data accompanied by submission of the type identifier data and the medium identifier data from the user terminal, and
the key issuance unit reads from the user key database a user key corresponding to the combination of the type identifier data and the medium identifier data submitted, and encrypts the content key data concerning the delivery request using the user key to make the transmitter to transmit it.

6. The storage medium processing device according to claim 4, comprising a family card registration database storing a family card registration data providing other storage media sharing content key data obtained in the storage medium,
wherein the user key database stores user key data of the other storage media provided in the family card registration data as being related to the type identifier data and the medium identifier data, and
the transmitter is configured to refer to the family card registration database and delivers the content key data held in the storage medium registered as a family card to the other storage medium, when the receiver receives from the user terminal the delivery request of the content key data accompanied by the submission of the type identifier data and the medium identifier data.

7. The storage medium processing device according to claim 4 wherein the storage medium is built into the user terminal.

8. The storage medium processing device according to claim 4, wherein the storage medium is attachable and detachable to and from the connecter of the user terminal.

9. A storage medium processing program a using a storage medium and a user terminal,
wherein the storage medium stores at least encrypted user key data in which user key data is encrypted so that it may be decrypted, and encrypted content key data in which content key data is encrypted so that it may be decrypted using the user key data, and the user terminal is configured to be connectable to the storage medium, and is enabled to access to a license center to obtain various kinds of data,
the program being configured to perform:
a user key data requesting step in which the user terminal requests to the license center an issuance of the user key data submitting type identifier data specifying a type of the storage medium with medium identifier data for discriminating one of storage media belonging to the same type; and
a user key data issuance step in which the license center issues different user key data per combination of the type identifier data and the medium identifier data submitted.

10. A storage medium processing program a using a storage medium and a user terminal,
wherein the storage medium stores at least encrypted user key data in which user key data is encrypted so that it may be decrypted, and encrypted content key data in which content key data is encrypted so that it may be decrypted using the user key data, and the user terminal is configured to be connectable to the storage medium, and is enabled to access to a license center to obtain various kinds of data,
the program being configured to perform:
a content key data requesting step in which the user terminal requests to the license center an issuance of content key data submitting type identifier data specifying a type of the storage medium with medium identifier data for discriminating one of storage media belonging to the same type; and
a content key data transmitting step in which the license center refers to a user key database storing the user key data as being related to the type identifier data and the medium identifier data reads from the user key database the user key data corresponding to the type identifier data and the medium identifier data submitted at the content key data requesting step and transmitting the content key data concerning the request to the user terminal after encrypting it with the user key data.
